(19) United States
(12) Patent Application Publication
(10) Pub. No.: US 2015/0146265 A1
(43) Pub. Date: May 28, 2015

(54) METHOD AND APPARATUS FOR RECOGNIZING DOCUMENT

(71) Applicant: Samsung Electronics Co., Ltd., Gyeonggi-do (KR)

(72) Inventors: Hee Jin Kim, Seoul (KR); Kyung Hwa Kim, Seoul (KR); Seon Hwa Kim, Seoul (KR); Jo Ah Choi, Seoul (KR)

(21) Appl. No.: 14/553,695

(22) Filed: Nov. 25, 2014

(30) Foreign Application Priority Data
Nov. 25, 2013 (KR) 10-2013-0143821

(51) Int. Cl. H04N 1/393; G06F 17/21; G06F 3/0488; H04N 1/409; G06K 9/18; G06K 9/62

(52) U.S. Cl. CPC H04N 1/393; G06K 9/18; G06K 9/6215; G06F 3/04883; H04N 1/409; G06F 17/214; H04N 2201/0084
USPC 358/450

(57) ABSTRACT

A method of recognizing characters in a plurality of documents includes capturing a preview image of a plurality of document, cropping each of the plurality of documents in the captured preview image into respective document images, recognizing characters on each of the plurality of the document images, and generating a document containing the plurality of the document images with the recognized characters. An apparatus for recognizing characters in a document includes a camera configured to capture a preview image of a plurality of document images, a display configured to display the preview image, and a controller configured to crop each of the plurality of documents in the captured preview image into respective document images, recognize characters on each of the plurality of the document images, and generate a document corresponding to the plurality of the document images with the recognized characters.

### CROSS-REFERENCE TO RELATED APPLICATION AND CLAIM OF PRIORITY

The present application is related to and claims priority from and the benefit under 35 U.S.C. §119(a) of Korean Patent Application No. 10-2013-0143821, filed on Nov. 25, 2013, which is hereby incorporated by reference for all purposes as if fully set forth herein.

### TECHNICAL FIELD

The present disclosure relates to a method and an apparatus for recognizing a document, which are capable of recognizing a plurality of documents.

### BACKGROUND

In general, a user directly inputs a document through a keyboard or a keypad, so that it is difficult to rapidly input the large amount of documents to an electronic device. As a necessity to store the large amount of documents in the electronic device is increased according to development of information processing, a demand for an automatic input operation has been increased.

Accordingly, a document recognizing method, which is capable of automatically recognizing a text or an image included in a document and storing the recognized text or image in the electronic device in a form of a file, and editing the stored file by using the stored document according to a purpose of a user and outputting the edited document, has been suggested.

### SUMMARY

In the meantime, the document recognizing method has a disadvantage in that when several sheets of documents are scanned at one time, the several sheets of documents are stored in a form of one image. In this case, there is a need for a process for separately editing the several sheets of documents included in one image by a user.

To address the above-discussed deficiencies, it is a primary object to provide a method and an apparatus for recognizing a document, which are capable of storing respective documents in the form of separate document files when several sheets of documents are scanned at one time.

The present disclosure provides a method and an apparatus for recognizing a document, which are capable of automatically editing sizes and aspect ratios of documents included in a scanned image to be equal to each other.

The present disclosure provides a method and an apparatus for recognizing a document, which are capable of maintaining an attribute value of a hand-writing font included in a recognized document. In accordance with an aspect of the present disclosure, a method of recognizing characters in a plurality of documents includes capturing a preview image of a plurality of document, cropping each of the plurality of documents in the captured preview image into respective document images, recognizing characters on each of the plurality of the document images, and generating a document corresponding to the plurality of the document images with the recognized characters.

In some embodiments, the method further comprises editing the plurality of document images according to an attribute value of a reference document.

In some embodiments, the method further comprises editing at least one of aspect ratios and sizes of the document images in the captured image to be equal to an aspect ratio and a size of the reference document image.

In some embodiments, wherein capturing of the preview image includes detecting document images included in the preview image, and designating one of the detected document images as a reference document.

In some embodiments, wherein designating the one of the detected document images includes, when aspect ratios of the document images are different from each other, requesting a user to select a document image among the cropped document images as the reference document, and when aspect ratios of the document images are same as each other, designating a document image having a smallest size among the document images as the reference document.

In some embodiments, wherein generating the document includes detecting one or more of texts and inserted images included in the document image, separating the texts and the inserted images, and simultaneously or sequentially recognizing the texts and recognizing the inserted images.

In some embodiments, wherein the recognizing of the texts includes, when the text included in the document image includes hand-writing characters, comparing similarities between each of the hand-writing characters and each of the hand-writing fonts stored in the storage unit, when one of the similarities exceeds a predetermined reference value, converting a hand-writing character into a hand-writing font with the exceeding similarity, and when the similarities are equal to or lower than the predetermined reference value, requesting a creation of a hand-writing font for a handwriting character.

In some embodiments, wherein recognizing the text includes converting the text included in the document image to digital data based on font information on a digital font.

In some embodiments, wherein recognizing the inserted images includes when the inserted image and the text overlap, separating the inserted image and the text, and correcting at least one of a color, a shape, and an effect of a region, in which the text is positioned within the inserted image, with a peripheral value.

In some embodiments, wherein recognizing the inserted images includes, when a background image is included in the inserted image, separating the background image and the inserted image and recognizing the separated background image and inserted image as one image.

An apparatus for recognizing a document includes a camera configured to capture a preview image of a plurality of document images, a display configured to display the preview image, and a controller configured to crop each of the plurality of documents in the captured preview image into respective document images, recognize characters on each of the plurality of the document images, and generate a document corresponding to the plurality of the document images with the recognized characters.

According to the various exemplary embodiments of the present disclosure, the method and the apparatus for recognizing a document may recognize several sheets of documents having different sizes at once and set a reference document among the recognized documents, thereby editing the several sheets of documents to have the same size and the same aspect ratio with an attribute value of the reference document, and storing the several sheets of documents as individual document files.

Further, according to the various exemplary embodiments of the present disclosure, the method and the apparatus for recognizing a document may classify images and texts within a recognized document and process the classified images and texts by separate recognition processes. Further, according to the various exemplary embodiments of the present disclosure, the method and the apparatus for recognizing a document may recognize a hand-writing input text included in a document, and store and share the recognized text in an editable form, thereby improving convenience and usability for a user.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram illustrating an electronic device according to various exemplary embodiments of the present disclosure;

FIG. 2 is a flowchart illustrating a document recognizing method according to various exemplary embodiments of the present disclosure;

FIG. 3 is a flowchart illustrating a document recognizing method according to various exemplary embodiments of the present disclosure;

FIG. 4 is a flowchart illustrating the document recognizing method according to various exemplary embodiments of the present disclosure;

FIG. 5 is a view illustrating an example of a preview screen image according to various exemplary embodiments of the present disclosure;

FIGS. 6A and 6B illustrate the examples of a reference document setting screen image according to various exemplary embodiments of the present disclosure;

FIGS. 7A and 7B are illustrate the examples of a document scanning screen image according to various exemplary embodiments of the present disclosure;

FIG. 8 is a view illustrating an example of a screen image, in which a margin within a document is cropped, according to various exemplary embodiments of the present disclosure;

FIGS. 9A to 9D illustrate the examples of screen images of edited recognized documents according to various exemplary embodiments of the present disclosure;

FIGS. 10A to 10C illustrate examples of the text recognition screen images according to various exemplary embodiments of the present disclosure; and

FIGS. 11A to 11C illustrate examples of the text and image recognition screen images according to various exemplary embodiments of the present disclosure.

### DETAILED DESCRIPTION

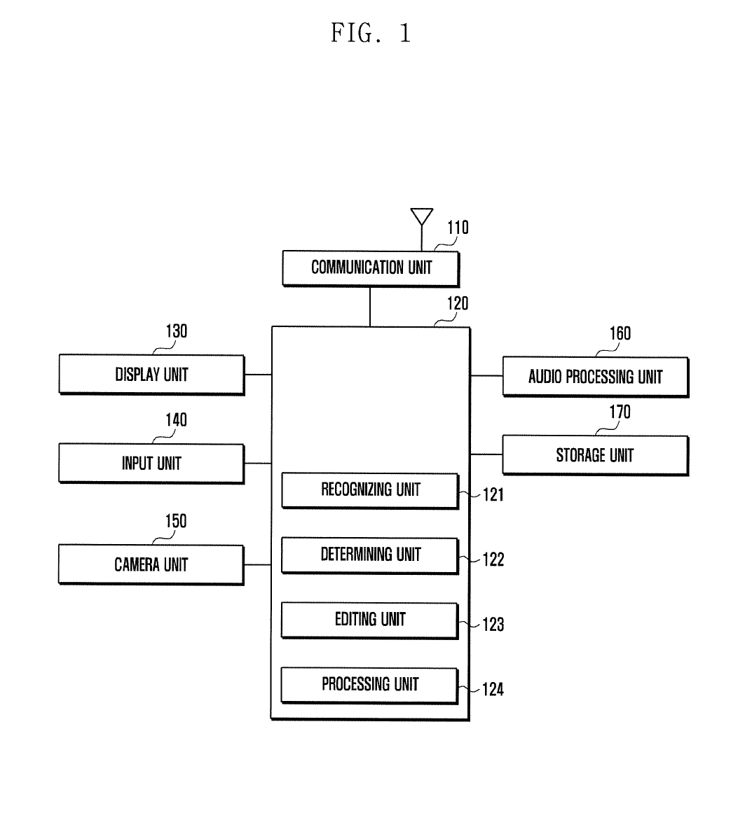

FIGS. 1 through 11C, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic devices. Hereinafter, various exemplary embodiments will be described in detail with reference to the accompanying drawings. It should be noted that the same elements will be designated by the same reference numerals although they are shown in different drawings. Further, in the following description of the present disclosure, a detailed description of known functions and configurations incorporated herein will be omitted when it may make the subject matter of the present disclosure rather unclear. In the following description, it is noted that only structural elements necessary for understanding operations according to various embodiments will be described, and the description of the other elements will be omitted in order to prevent obscuring of the subject matter of the present disclosure.

An electronic device according to various embodiments of the present disclosure may be a device including a communication function and a camera function (or scan function). For example, the electronic device may be one or a combination of a smart phone, a tablet Personal Computer (PC), a mobile phone, a video phone, an e-book reader, a desktop PC, a laptop PC, a netbook computer, a Personal Digital Assistant (PDA), a Portable Multimedia Player (PMP), an electronic accessary, a camera, a wearable device, an electronic clock, a wrist watch, smart white appliances, various types of medical devices (for example, Magnetic Resonance Angiography (MRA), Magnetic Resonance Imaging (MRI), Computed Tomography (CT), scanner, an ultrasonic device, and the like), a navigation device, a Global Positioning System (GPS) receiver, an Event Data Recorder (EDR), a Flight Data Recorder (FDR), a set-top box, an electronic dictionary, a in-vehicle infotainment device, electronic equipment for a ship (for example, a navigation device for ship, a gyro compass, and the like), avionics, a security device, electronic clothes, an electronic key, a camcorder, game consoles, a Head-Mounted Display (HMD), a flat panel display device, an electronic album, a part of furniture or building/structure having a communication function, an electronic board, an electronic signature receiving device, and a projector. It is obvious to those skilled in the art that the electronic device according to the present disclosure is not limited to the aforementioned devices.

In various exemplary embodiments of the present disclosure, a “document” or a “document image” means a material in the form of a document written and transceived or stored in an electronic form in an electronic device.

FIG. 1 is a block diagram illustrating a configuration of an electronic device according to various exemplary embodiments of the present disclosure.

Referring to FIG. 1, the electronic device according to various exemplary embodiments of the present disclosure may support a function of recognizing document images included in a preview image, a function of selecting a reference document from the document images, a function of editing aspect ratios and sizes of the recognized document images based on an attribute value of the reference document, a function of cropping a margin or a background other than the recognized document images, a function of recognizing an inserted image and text included in the document image, a function of setting a hand-writing input font, and a function of storing each of the recognized document images in a form of a separate file.

The electronic device according to an exemplary embodiment may include a communication unit 110, a controller 120, a display unit 130, an input unit 140, a camera unit 150, an audio processor 160, and a storage unit 170.

The communication unit 110 may establish a communication channel with a supportable mobile communication network, and support a function of performing at least one of voice communication, video communication, and data communication under the control of the controller 120. The communication unit 110 may be driven according to a communication function request from a user, set schedule information, or an external request. The communication unit 110 may include at least one of a wireless communication module or an RF module. The wireless communication module may include at least one of, for example, WiFi™, BlueTooth (BT)™, GPS, and Near Field Communication (NFC). For example, the wireless communication module may provide a wireless communication function by using a wireless frequency. Additionally or alternatively, the wireless communication module may include a network interface (for example, a LAN card), a modem, or the like for connecting hardware to a network (for example, Internet, a local area network (LAN), a wide area network (WAN), a telecommunication network, a cellular network, a satellite network, a plain old telephone service (POTS), or the like). The RF module may serve to transceive data, for example, an RF signal or a called electronic signal. The RF module may include, for example, a transceiver, a Power Amp Module (PAM), a frequency filter, a Low Noise Amplifier (LNA), or the like, which are not illustrated in the drawing. Furthermore, the RF module may further include a component, such as a conductor or a conducting wire, for transceiving electronic waves over a free air space in wireless communication.

The controller 120 controls the supply of power from a battery to the internal elements. When power is supplied, the controller 120 can control a booting process of the electronic device, and execute various application programs stored in a program region in order to execute a function according to the setting of the user. The controller 120 can include one or more Application Processors (APs) or one or more Communication Processors (CPs).

The controller 120 according to one exemplary embodiment can include a recognizing unit 121, a determining unit 122, an editing unit 123, and a processing unit 124.

The recognizing unit 121 can detect a document image, which is presumed as a document, from a preview image or a scanned image, and recognize at least one of an inserted image and text included in the document image.

The determining unit 122 determines aspect ratios of the document images included in the preview image or the scanned image, and selects one of the document images included in the preview image or the scanned image as a reference document according to a predetermined rule. Further, the determining unit 122 can store an attribute value (for example, an aspect ratio and a size value) of the reference document selected by a user control input or the predetermined rule.

The editing unit 123 recognizes borders of the document images included in the scanned image and cropping a margin or a background other than the document, and editing an aspect ratio and a size of the cropped document image with the attribute value of the reference document.

The processing unit 124 can classify the inserted image and text included in the document image, and correct and edit the classified inserted image or text, and identify a font of the text included in the document to convert the text into digital data.

The display unit 130 can display an image or data to the user. The display unit 130 can include a display panel. For example, a Liquid Crystal Display or an Active Matrix-Organic Light Emitting Diode (AM-OLED) can be used as the display panel. In this case, the display unit 130 can further include a controller controlling the display panel. The display panel can be embodied to be, for example, flexible, transparent, or wearable. In the meantime, the display unit 130 can be combined with a touch panel to be provided in the form of a touch screen. For example, the touch screen can include an integrated module in which the display panel and the touch panel are combined in a stack structure.

When the document recognizing function is executed, the display unit 130 can receive a preview image collected through a camera from the controller 120, and convert the received preview image to an analog signal and output the analog signal. The display unit 130 can overlap and display menu items, which are capable of controlling the document recognizing function, on the preview image. The preview image can be an image, in which high resolution of raw data is decreased to low resolution according to a size of a screen, output on the display unit 130. Here, the raw data means an image in the digital form, which is generated by the camera unit 150 and is not processed.

Further, the display unit 130 can capture a preview image in response to the user input control, and output the captured scanned image under the control of the controller. The scanned image means a still image in the digital form in which the captured image in the preview image is processed to have high resolution.

The input unit 140 can generate a signal related to the user setting and the control of a function of a terminal and transmit the generated signal to the controller 120. The controller 120 can control functions according to corresponding input signals in response to the key signal. The input unit 140 can include a touch panel, a pen sensor, and a key. The touch panel can recognize a touch input based on at least one scheme among, for example, a capacitive scheme, a resistive scheme, an infrared scheme, and an ultrasonic wave scheme. The touch panel can further include a controller (not illustrated). Meanwhile, in the capacitive type, a proximity recognition is possible as well as a direct touch. The pen sensor can be implemented by using, for example, a separate pen recognizing sheet by the same method as that of receiving a touch input of a user. The key can include, for example, a mechanical key or a touch key.

The camera unit 150 can photograph an image and a video, and transmit the photographed image and video to the controller 120. The camera unit 150 can include one or more image sensors (for example, a front lens or a rear lens), an Image Signal Processor (IPS), or a flash LED. When the execution of the document recognizing function is requested, the camera unit 150 can be activated as a background function under the control of the controller 120.

The audio processor 160 can include a speaker 151 for outputting audio data received through the communication unit 110 and audio data stored in the storage unit 160, and a microphone 162 for collecting a voice of a user or other audio signals. The audio processor 160 can bi-directionally convert a voice and an electrical signal. The audio processor 160 can include at least one of, for example, a speaker, a receiver, an earphone, and a microphone, and convert input or output voice information.

The storage unit 170 stores a command or data received from or generated by the controller 120 or other elements (for example, the display unit 130, the input unit 140, and the communication unit 110). The storage unit 170 stores an Operating System (OS) for booting the electronic device and operating each element, one or more application programs, a message transceived with a network, and data according to execution of an application.

The storage unit 170 can include at least one of an internal memory and an external memory. The internal memory can include at least one of a volatile memory (e.g. a Dynamic Random Access Memory (DRAM), a Synchronous Dynamic RAM (SDRAM), etc.), a non-volatile memory (e.g. an One Time Programmable Read-Only Memory (OTPROM), a Programmable ROM (PROM), an Erasable and Programmable ROM (EPROM), an Electrically Erasable and Programmable ROM (EEPROM), a Mask ROM, a Flash ROM, etc.), a Hard Disk Drive (HDD), or a Solid State Drive (SSD). The external memory can include at least one of, for example, a Compact Flash (CF), a Secure Digital (SD), a Micro Secure Digital (Micro-SD), a Mini Secure Digital (Mini-SD), an extreme Digital (xD) and a memory stick.

The names of the above described components of an electronic device according to the present disclosure can vary depending on the type of the electronic device. An electronic device according to an embodiment of the present disclosure can be formed to include at least one of the described component elements, and a few component elements can be omitted or additional component elements can be further included. Also, some of the components of the electronic device according to the present disclosure can be combined to form a single entity, and thus can equivalently execute functions of the corresponding components before being combined.

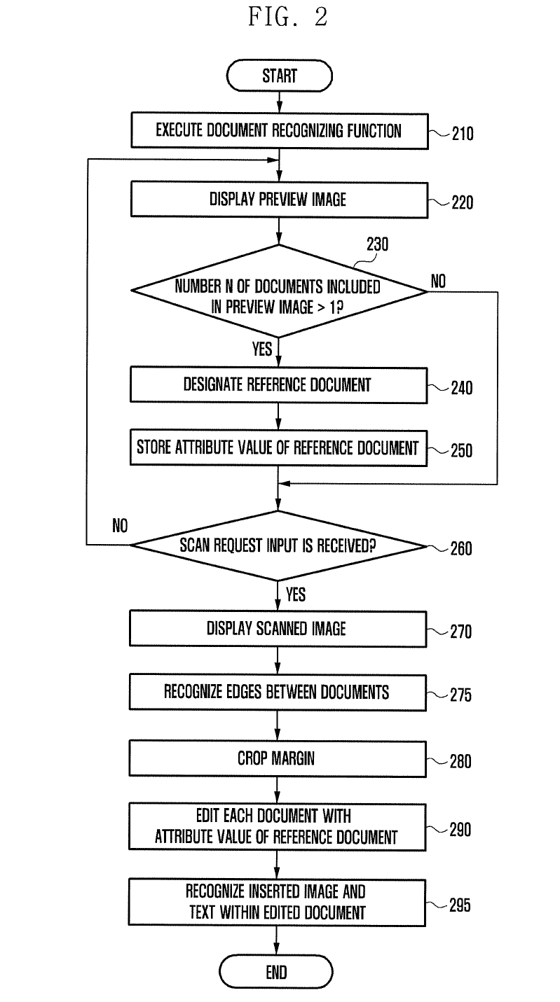

FIG. 2 is a flowchart illustrating the document recognizing method according to various exemplary embodiments of the present disclosure.

Referring to FIG. 2, the controller 120 can execute the document recognizing function according to a predetermined schedule or a user input control in operation 210. In this process, the controller 120 can activate (turn on) the camera unit 150 in response to the request for the execution of the document recognizing function.

The controller 120 can display a preview image collected through the camera unit 150 on the display unit 130 in operation 220. The user can control a position of the electronic device so that documents, which are to be recognized, are included in the preview image.

The controller 120 determines whether the number of document regions included in the preview image exceeds 1 in operation 230. For example, the controller 120 can output the preview image through the display unit 130, and detect document images included in the image by using data of the preview image which is temporarily stored as a background. In various exemplary embodiments, the controller 120 can use various determination algorithms in order to detect the document images in the preview image.

In one exemplary embodiment, the controller 120 can use an algorithm for extracting a contour line of an object by using continuity of an inclination degree of brightness, color, and aroma. In this case, the controller 120 can compare similarity between the extracted contour line of the object within the image and a specific figure (for example, a quadrangle and a rectangle) and determine the document region.

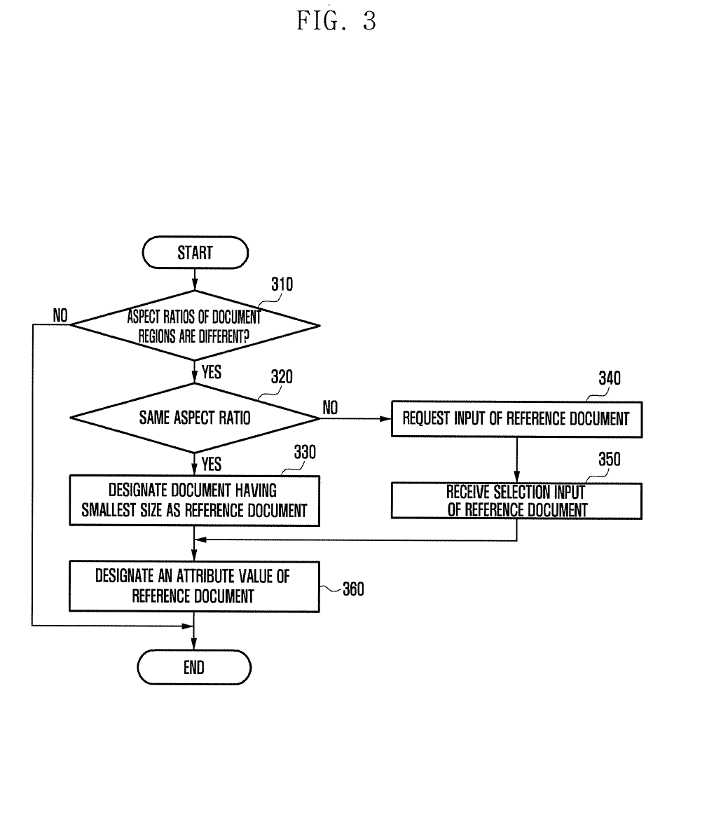

When the number of document images included in the preview image exceeds 1, the controller 120 can designate a reference document in operation 240. Here, the reference document can be one of a randomly selected document image, a document image selected by a predetermined rule, and a document image selected by a user input. An exemplary embodiment for a method of designating the reference document will be described with reference to FIG. 3 below.

The controller 120 can store an attribute value of the document image which is pre-designated as the reference document in operation 250. Here, the attribute value can include an aspect ratio and a size value of the document region.

The controller 120 determines whether a scan request input is received in operation 260, and when the scan request input is received, the controller 120 displays a scanned image on the display unit 130 in response to the received scan request input in operation 270. The scanned image can be a still image obtained by capturing the preview image and processing the capture image to have high resolution.

In the meantime, in the document recognition process according to one exemplary embodiment of the present disclosure, operations 240 and 250 are performed as the background in the state where the preview image is output on the display unit, but the present disclosure is not limited thereto.

In another exemplary embodiment, in the document recognition process, operations 240 and 250 can be changed next to the state where the scanned image is displayed on the display unit (for example, operation 270). For example, the controller can detect document images, which are presumed as documents, in the scanned image based on scan image data, designate a reference document among the detected document images, and store an attribute value of the reference document.

The controller 120 detects edges of the document images included in the scanned image and recognizes one or more documents in operation 275.

The controller 120 can crop a margin (or a background) except for the recognized document images in operation 280. In this process, the controller 120 can process the cropped margin or background to be transparent (or white) so as to be discriminated from the recognized document images, but the present disclosure is not limited thereto. For example, the controller 120 can crop the margin (or the background) other than the document images by using a crop tool.

The controller 120 can edit at least one of the size and the aspect ratio of at least one recognized document image with the attribute value of the reference document in operation 290, and the controller 120 can recognize and process at least one of an inserted image and an inserted text included in the edited document image in operation 295. Then, the controller 120 can store each of the recognized documents in the form of one page or file.

In the meantime, in one exemplary embodiment, the controller 120 sequentially performs the operations of recognizing the edges of the documents, cropping the margin, and recognizing at least one of the inserted image and the inserted text, but the present disclosure is not limited thereto, and the aforementioned processes can be independently or simultaneously performed.

FIG. 3 is a flowchart illustrating the method of setting the reference document in the electronic device according to various exemplary embodiments of the present disclosure.

Referring to FIG. 3, according to various exemplary embodiments of the present disclosure, the controller 120 can designate the reference document in the preview image or the scanned image according to the predetermined rule or the user input.

According to various exemplary embodiments of the present disclosure, the controller 120 can determine whether aspect ratios of the documents included in the preview image are different from each other in operation 310. For example, the controller 120 can detect document images, which are presumed as document, in the temporarily stored preview image or scanned image, and measure the aspect ratios by measuring horizontal values and vertical values of the detected document images.

In the meantime, the controller 120 can make a control so that information on the aspect ratios of the documents images is output on the preview image or the scanned image, but the present disclosure is not limited thereto.

When the aspect ratios of the document images are not different from each other, the controller 120 determines that the aspect ratios of the document images are the same in operation 320, and the controller 120 can compare sizes of the documents and designate a document image having the smallest size as the reference document in operation 330.

When the aspect ratios of the document images are different from each other, the controller 120 provides information requesting selection of a reference document to the display unit 130 in operation 340, and the controller 120 can receive a selection signal of the user and designate the selected document image as the reference document in operation 350. For example, the controller 120 can provide a menu item for requesting selection of the reference document overlapping the preview image to the display unit 130, and receive a selection signal of the user for selecting one of the document images included in the preview image.

For another example, the controller 120 can provide a menu item for requesting selection of the reference document overlapping the scanned image to the display unit 130, and receive a selection signal of the user for selecting one of the document images included in the scanned image.

The controller 120 can designate an attribute value, for example, an aspect ratio and a size value, of the designated reference document in operation 360.

Further, in another exemplary embodiment, the controller 120 can randomly select a predetermined document among the document image included in the preview image or the scanned image, and set the selected predetermined document as the reference document.

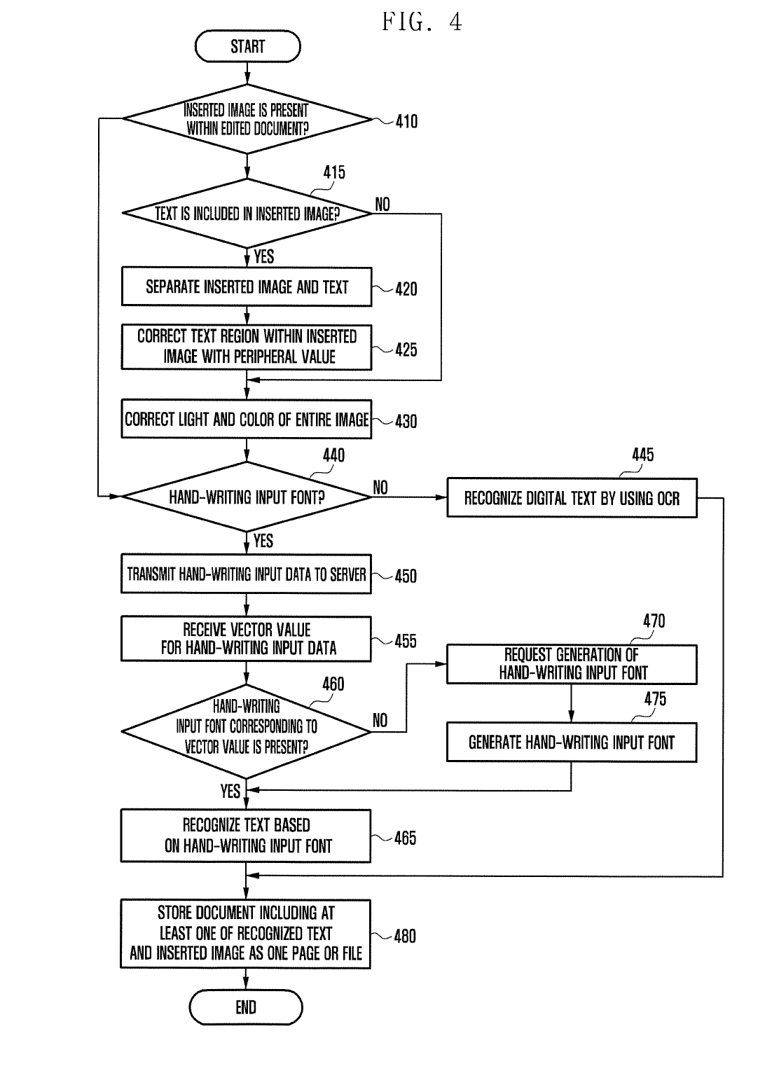

FIG. 4 is a flowchart illustrating the document recognizing method according to various exemplary embodiments of the present disclosure.

Referring to FIG. 4, the controller 120 can determine whether an inserted image is present in the document in operation 410, and when the inserted image is present in the document, the controller 120 can separate the inserted image and a text from each other, and separately recognize each of the separated image and text in operation 415.

In the meantime, when the inserted image is not present in the document, the controller 120 can recognize the text included in the document in operation 440.

The controller 120 determines whether the inserted image is combined with the text in operation 420, and when the inserted image included in the document is combined with the text, the controller 120 can correct at least one of a color, a shape, and an effect of a region, in which the text is positioned in the inserted image, with a peripheral value in operation 425.

In the meantime, the controller 120 can correct light reflection of the recognized document, and adjust brightness and contrast of the recognized document in operation 430, but the present disclosure is not limited thereto, and operation 430 can be omitted if necessary.

The controller 120 identifies fonts of the separated texts and determines whether characters in the document have any hand-writing letters in operation 440.

For example, in a digital font, the characters can have the same size and the uniform shape, but in a hand-writing input font, the characters can have different sizes and non-uniform shapes.

When the characters in the document region have the digital font, the controller 120 can convert a foam of a character or a symbol, such as a number, an alphabet letter, a consonant, and a vowel of a specific form, into digital data by using an optical character reader and recognize the form of the character or the symbol in operation 445. For example, when there is a digital font corresponding to the character based on font information about the character, character interval information, and character contour information, the controller 120 can convert the characters to digital data based on font information on the corresponding digital font.

When the recognized characters have the hand-writing input font, the controller 120 transmit hand-writing input data corresponding to the hand-writing character or symbol to the server in operation 450, and receives a vector value for the hand-writing input data from the server in operation 455. The controller 120 determines whether the hand-writing input font corresponding to the received vector value is present in the terminal in operation 460.

In one exemplary embodiment, when the hand-writing input font corresponding to the characters included in the document is present (or stored) in the electronic device, the controller 120 can convert the hand-writing characters based on the font information on the corresponding hand-writing input font in operation 465. For example, the controller 120 can compare font information on a hand-writing input font stored in the terminal and the font information on the hand-writing characters included in the document, and when similarity is equal to or greater than a predetermined value (for example, N %), the controller 120 can convert the hand-writing input characters to digital data based on the font information on the hand-writing input font stored in the terminal.

In another exemplary embodiment, when the hand-writing font exists (or stored) in the electronic device, the controller 120 can request generation of a hand-writing font in operation 470, and generate a hand-writing input font according to a hand-writing input font generation procedure in operation 475. For example, the controller 120 can provide the display unit 130 with a request menu item for requesting font information on the hand-writing font, and font data information input according to a control input of the user, convert the received font data information to digital data, and generate a hand-writing font with font types and sizes corresponding to the hand-writing letters. In the meantime, in one exemplary embodiment, the electronic device can transmit information on a hand-writing font generated by the electronic device to the server, and share the information with users using the server.

The controller 120 can combine at least one of the recognized text and image with the corresponding document, and store each of the recognized documents in the form of one page or file in operation 480.

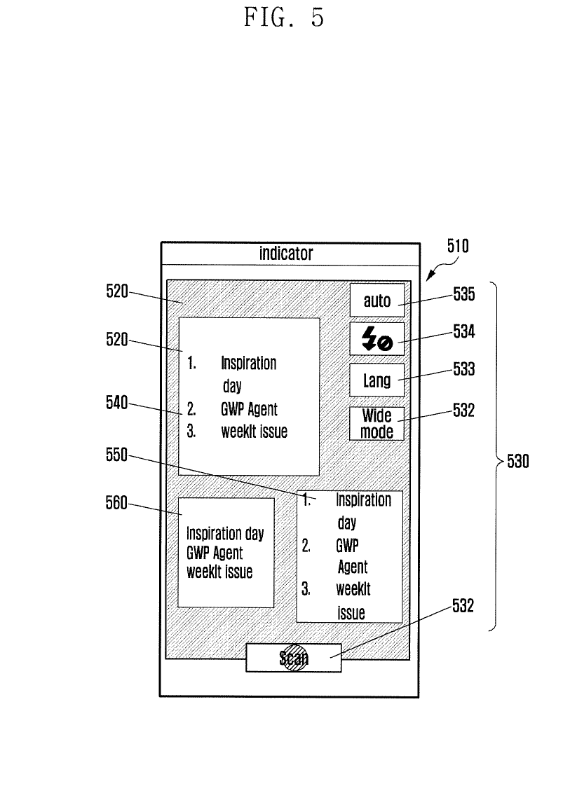

FIGS. 5 to 11 illustrate the screen images for performing the document recognition according to various exemplary embodiments of the present disclosure.

FIG. 5 illustrates the example of a screen image of a preview image. Referring to FIG. 5, the user can execute the document recognizing function and activate the camera unit 150. In response to this, the controller 120 can be currently operated in a document recognition mode. In this process, the controller 120 can output a preview image 510 collected through the camera unit 150 on the display unit 130. Further, the controller 120 can temporarily store the preview image collected through the camera in a buffer in the document recognition mode.

The preview image 510 can include a view region 520, on which the image collected through the camera is output, and a function key region 530. The function key region 530 can include at least one of a scan item 531 for scanning an image, a light on/off setting item 534, a language setting item 533, a screen image mode shift item 532, and an automatic focus setting item 535, but is not limited thereto. The function key region 530 can include various items for controlling the character recognizing function. The image collected through the camera, on which image processing and buffering have been performed, can be output on the view region 520.

The user can control the camera unit 150 so that documents to be recognized are output on the view region 520. For example, as illustrated in FIG. 5, the user can dispose three documents, which are recognition targets, and control the camera unit 150 so that the three documents are included in the view region in order to recognize the three documents by one scanning.

Then, the controller 120 can detect document images 540, 550, and 560, which are presumed as documents, within the preview image serving as a background while outputting the preview image on the display unit 130. For example, the controller 120 can recognize a region presumed as a document by tracing an object presumed as a document or detecting an edge through the preview image stored in the buffer. The controller 120 can measure an aspect ratio and a size of the document image (or the document) presumed as the document.

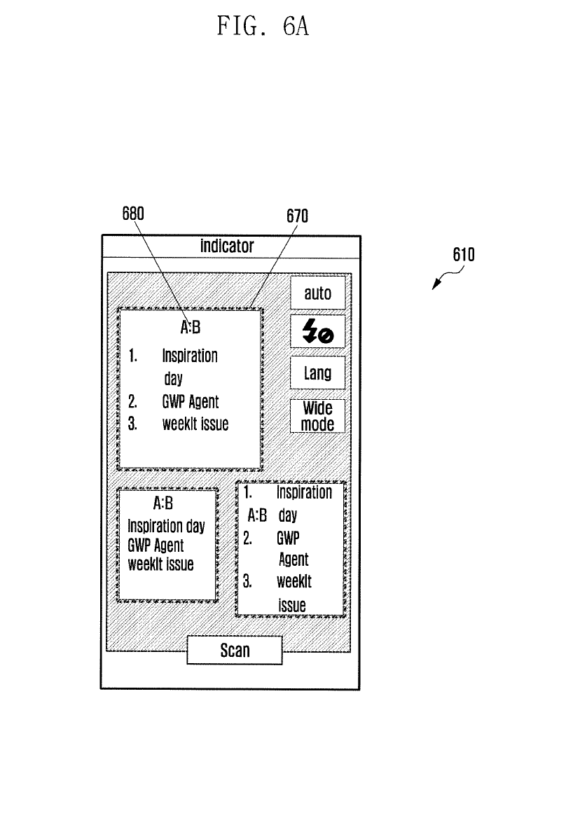

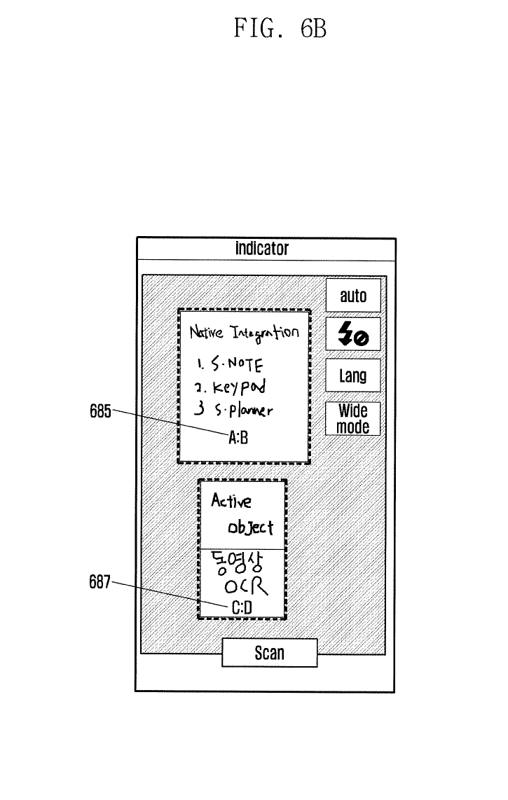

FIGS. 6A and 6B illustrate examples of the reference document setting screen image.

Referring to FIG. 6, the controller 120 can determine the aspect ratios and the sizes of the detected document images, and compare the document images to designate a reference document. The controller 120 can store an aspect ratio and a size value of the reference document. Here, edges of the document images included in the preview image of FIG. 6 are indicated by dotted lines, but this is simply illustrated for describing the contents of the detection of the region presumed as the document in the background, and the display unit 130 can continuously output the preview image collected from the camera.

In one exemplary embodiment, when the document images detected in the preview image have the same aspect ratio, the controller 120 can designate the smallest document among the detected document images as the reference document. For example, as denoted by reference numeral 601, when three document images 640, 650, and 660 having the same aspect ratio (for example, the ratio of A:B) are detected in the preview image 610, the controller 120 can set the smallest document 660 among the three document images as the reference document.

In this case, the controller 120 can graphically process the document 660, which is designated as the reference document, so that the document 660 is visually discriminated from other documents 640 and 650 for display, but the present disclosure is not limited thereto. Further, the controller 120 can control the display unit 130 so that an aspect ratio value 680 of the documents detected in the preview image overlap on the respective documents, but the present disclosure is not limited thereto.

In one exemplary embodiment, when the document images detected in the preview image have different aspect ratios, the controller 120 can request selection of a reference document, and set a document selected according to a user input as the reference document. For example, the controller 120 can detect two document images 685 and 687 having different aspect ratios in the preview image as denoted by reference numeral 602. For example, when one document 685 has the ratio of A:B, and another document 687 has the ratio of C:D, the controller 120 can output a request message requesting the selection of the reference document, or a reference document setting unavailable message on the preview image.

Then, the controller 120 can receive a user selection input, and set the document selected by the user as the reference document.

In one exemplary embodiment, the controller 120 can randomly designate the reference document from among the documents detected in the preview image according to a document recognition setting option.

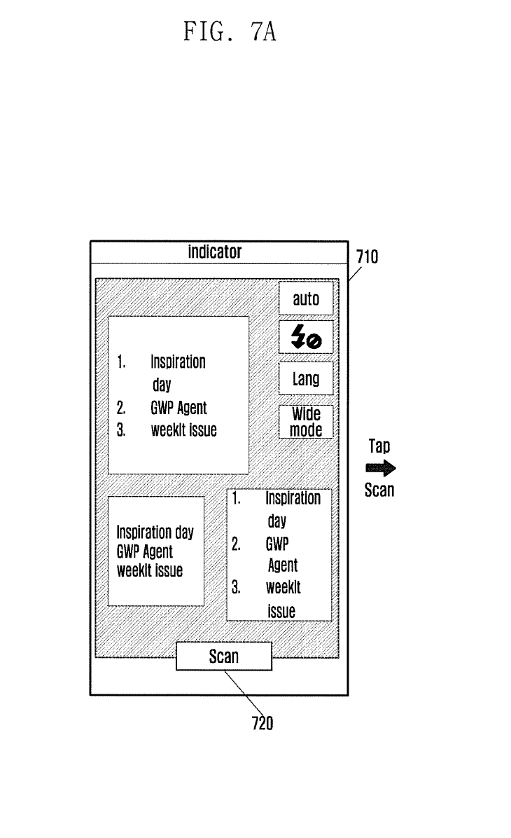

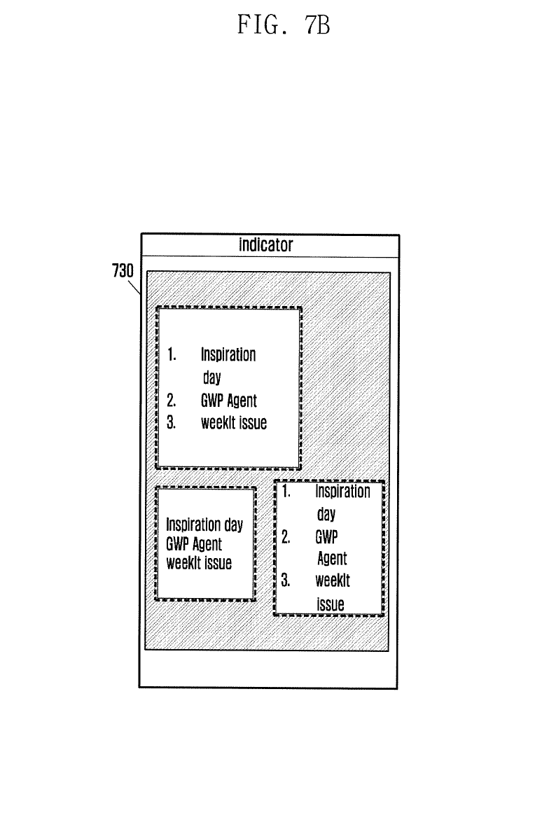

FIGS. 7A and 7B illustrate examples of a document scanning screen image.

Referring to FIGS. 7A to 7B, the user can select a scan item 720 in order to recognize documents included in a preview image. Then, the electronic device can capture and store the preview image collected through the camera unit in response to a selection input of the scan item 720, and output the stored scanned image on the display unit. Here, the scanned image means a still image in the digital form in which the captured image in the preview image is processed to have high resolution. In one exemplary embodiment, when the controller includes a touch screen, the user can touch or tap the scan item 720.

As indicated by reference numeral 701, when a preview image 710 is output on the display unit 130, and the scan item 720 is selected, the controller 120 can output the captured scanned image on the display unit as denoted by reference numeral 702.

In this case, the controller 120 can simultaneously perform a recognition process for recognizing the document. Here, in the recognition process, a document edge recognition process, a text recognition process, and an image recognition process can be simultaneously or sequentially performed.

For example, as denoted by reference numeral 702, the controller 120 can detect edges of the document images which are presumed as documents, and display the detected edges by dotted lines.

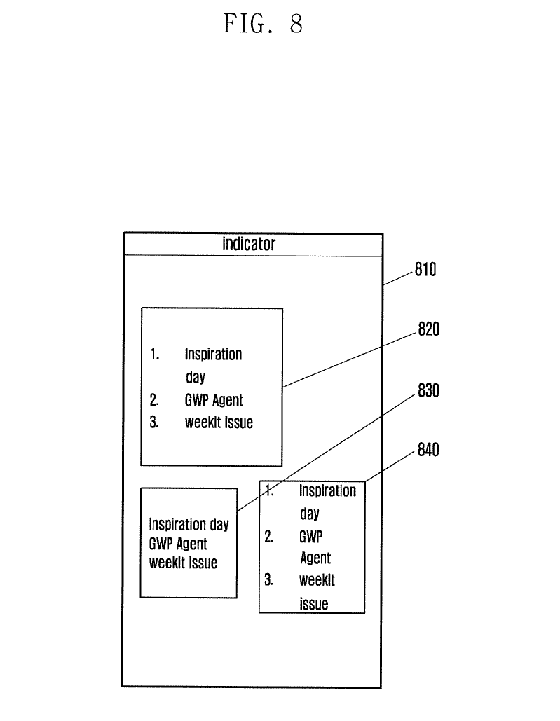

FIG. 8 is a view illustrating an example of a screen image, in which a margin within a document is cropped.

Referring to FIG. 8, the controller 120 can recognize the edges of the document images included in the scanned image, and crop a margin (or a background) other than the document images. According to one exemplary embodiment, the controller 120 can crop the margin based on the edges of the document images in the scanned image 702 of FIG. 7, and output an image 810, in which the margin is cropped, on the display unit.

In one exemplary embodiment, the controller 120 can graphically process (for example, change a color to white and the like, or process to be transparent) the document image so that the cropped portion is visually discriminated. In this case, the document images left within the edges are separated, and the controller 120 can recognize the separated document images as one document, and perform a process of recognizing an inserted image and text on each of the recognized documents.

For example, after the margin is cropped, the controller 120 can recognize respective document images 820, 830, and 840 left within the edges in the screen image as one document, and recognize that the three documents are scanned.

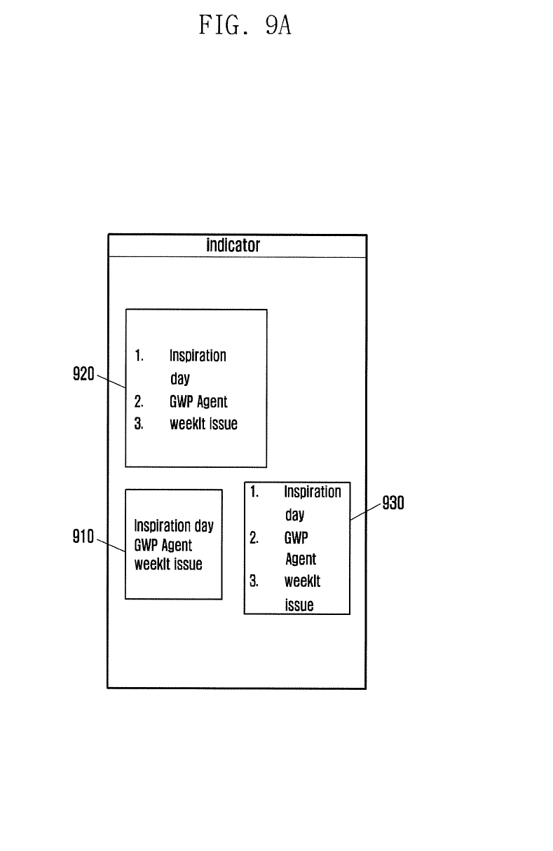

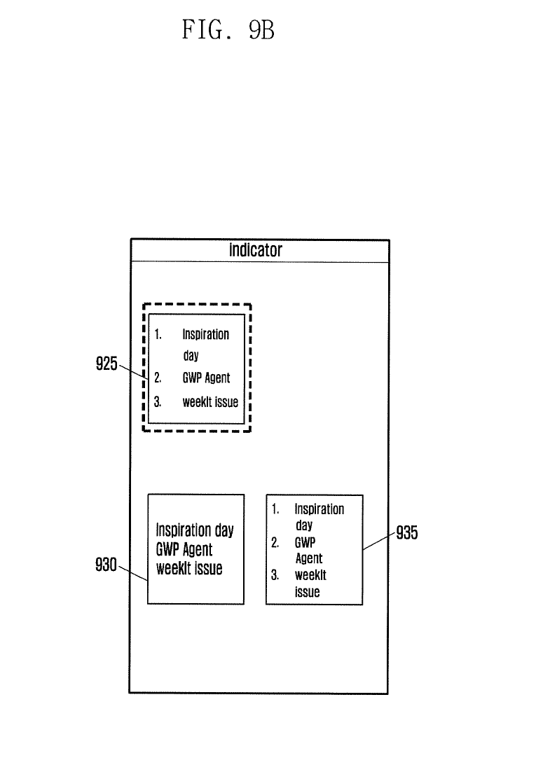

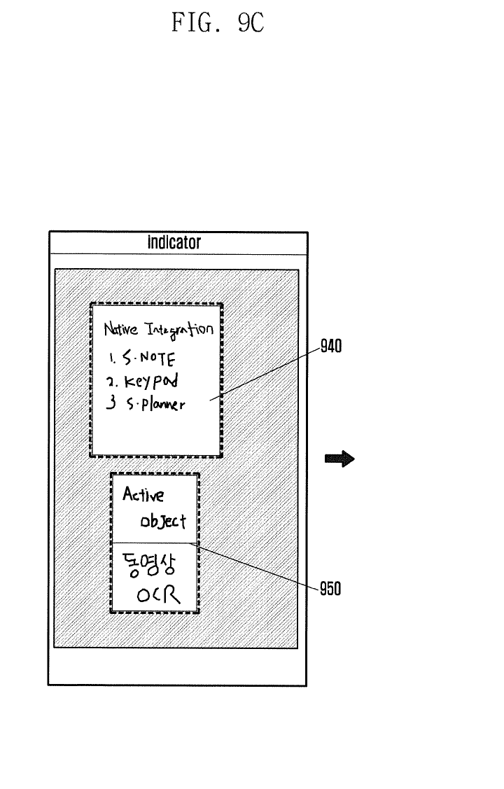

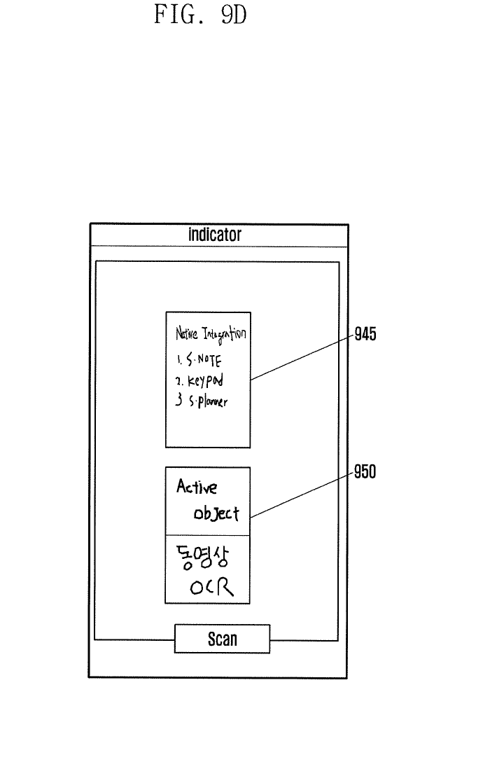

FIGS. 9A to 9D illustrate examples of screen images of edited recognized documents.

Referring to FIGS. 9A to 9D, the controller 120 can edit the sizes and the aspect ratios of the recognized documents to be equal to a setting value of the set reference document.

According to one exemplary embodiment, when the aspect ratios of the respective documents images are the same, the controller 120 can designate the smallest document as the reference document, and enlarge or reduce the sizes of other documents. For example, as denoted by reference numeral 901, aspect ratios of a second document image 920 and a third document image 930 are the same as an aspect ratio of a first document image 910, so that the controller 120 can designate the first document image 910 as the reference document. In this case, the controller 120 can reduce the second document image 920 to have the same size as that of the first document image 910. Further, the controller 120 can reduce the third document image 930 to have the same size as that of the first document image 910.

According to another exemplary embodiment, when aspect ratios of the respective document images are different from each other, the controller 120 can designate a document randomly selected or selected according to a user input as the reference document, and edit the aspect ratios and the sizes of other documents to be the same as the aspect ratio and the size of the reference document. For example, as denoted by reference numeral 902, when aspect ratios of two document images 940 and 950 are different from each other, the controller 120 can designate the first document image 950 as the reference document, and edit an aspect ratio and a size of the other document image 950 based on an attribute value of the first document image 950.

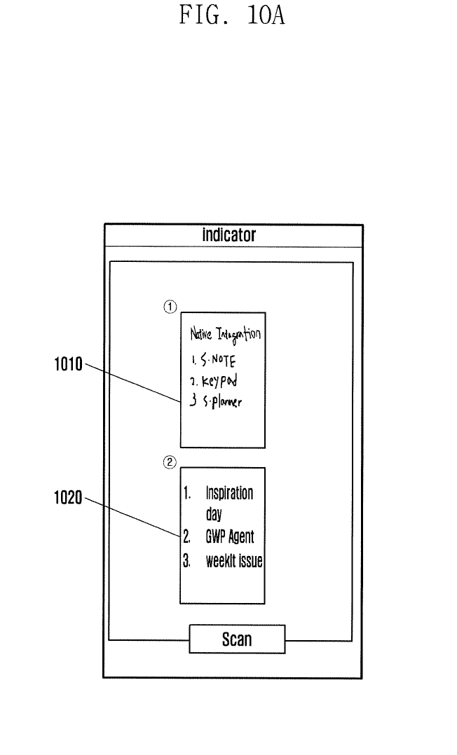

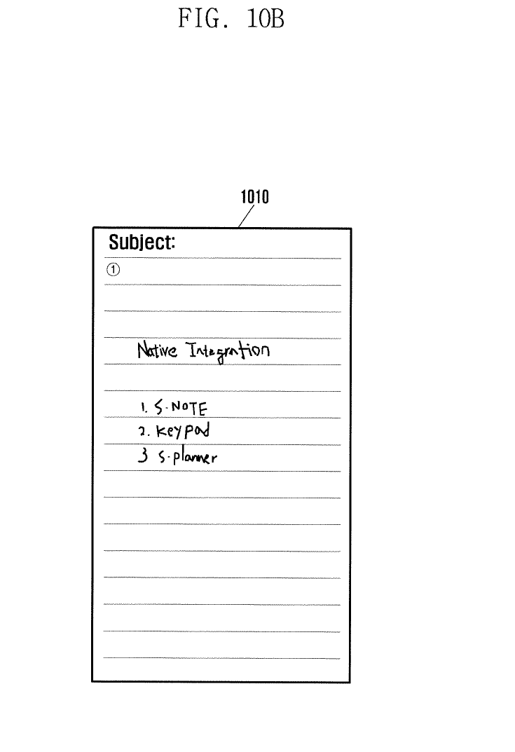

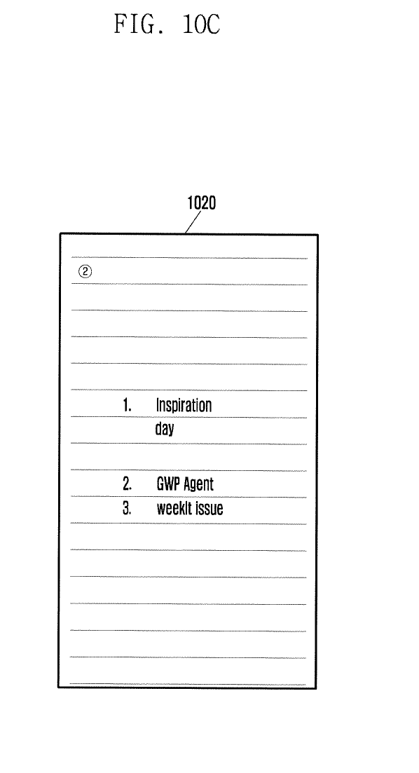

FIGS. 10A to 10C illustrate examples of the text recognition screen image.

Referring to FIGS. 10A to 10C, the controller 120 can distinguish an attribute of the text included in the recognized document and recognize characters. For example, the controller 120 can extract a recognized character or symbol, and convert the extracted character or symbol to digital data. Further, the controller 120 can store each of the recognized documents in the form of one file or page.

For example, as denoted by reference numeral 1001, the controller 120 can recognize a first document image 1010 including characters input through hand-writing, and a second document image 1020 including characters written in a digital font.

In one exemplary embodiment, the controller 120 can determine that there is no digital font corresponding to the text based on font information, character interval information, and character contour information about the text included in the document. In this case, the controller 120 can transmit text data included in the first document image 1010 to a server providing a vector value, and receive a vector value corresponding to the hand-writing input from the server.

Then, the controller 120 can compare similarity between the text data and the hand-writing input font stored in the terminal, and when the similarity exceeds a predetermined reference value, the controller 120 can generate a first document 1010a based on font information on the corresponding hand-writing input font. In one exemplary embodiment, when there is a digital font corresponding to the text based on the font information, the character interval information, and the character contour information about the text included in the document, the controller 120 can generate a second document 1020a based on font information on the digital font corresponding to the text as denoted by reference numeral 1003.

In this case, each of the generated first document 1010a and the second document 1020a can be stored and managed in the form of one page or file.

In the meantime, in one exemplary embodiment, when the hand-writing input font corresponding to the hand-writing input is not stored in the terminal, the controller 120 can perform a procedure of generating a hand-writing input font. For example, when the controller 120 outputs an item requesting new generation of a hand-writing input font on the screen, and responds to the request for the generation of the hand-writing input font, the controller 120 can provide a screen image (for example, a screen image for requesting an input of a consonant, a vowel, a small letter, a capital letter, a symbol, and the like) requesting a character font table, and generate the hand-writing input font based on data of the characters input by the user.

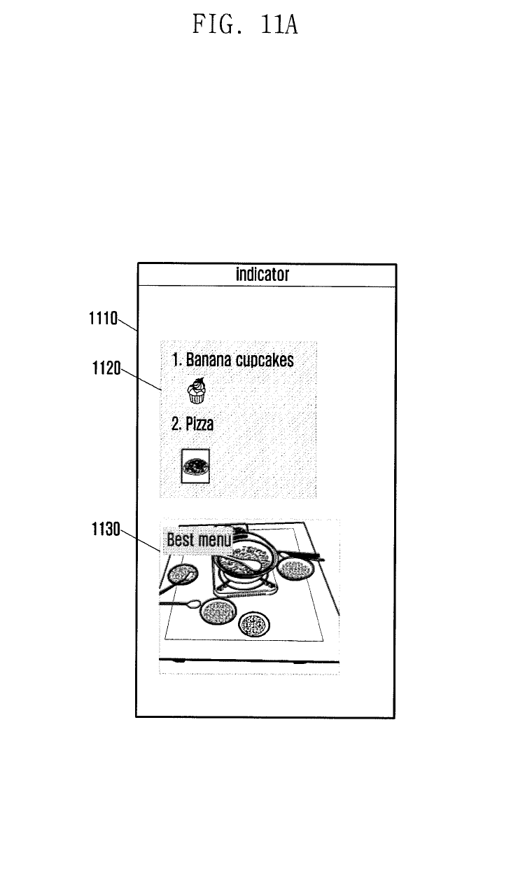

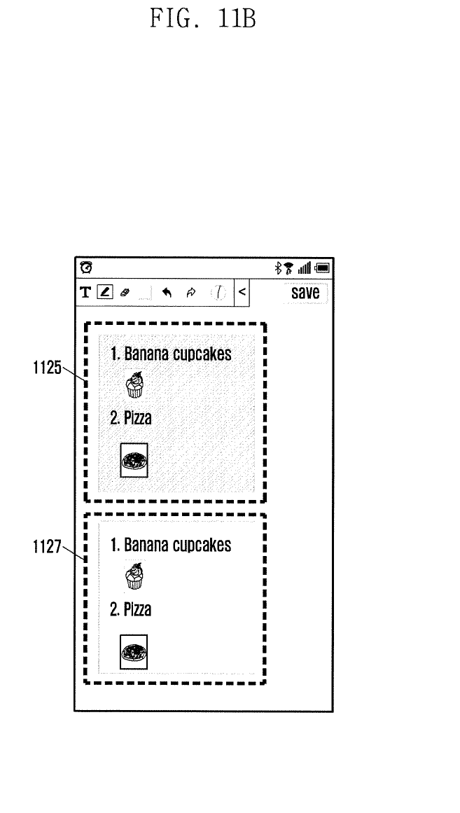

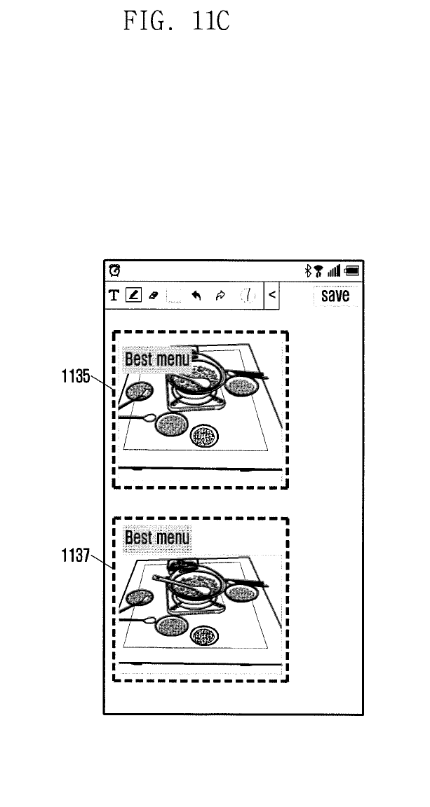

FIG. 11A to 11C illustrate examples of the text and image recognition screen images.

Referring to FIGS. 11A to 11C, the controller 120 can separate texts and images included in the document, and separately recognize and process each of the separated texts and images. For example, as denoted by reference numeral 1101, the controller 120 can output a scanned image 1110 including a first document image 1120 in which inserted images do not overlap texts, and a second document image 1130 in which inserted images overlap a text on the display unit.

In one exemplary embodiment, the first document image 1120, in which the inserted images do not overlap the texts, can include a background image, the inserted images, and the texts. The controller 120 can separate the images and the texts and perform a process of recognizing the texts. Further, the controller 120 can recognize the inserted images and the background image as one entire image as denoted by reference numeral 1125.

Further, as denoted by reference numeral 1127, the controller 120 can exclude a background image, separate the inserted images, and perform a process of recognizing the inserted images. In this case, as illustrated, the document image can be generated as a document excluding the background image and including only the inserted images and the text.

In another exemplary embodiment, the second document image 1130, in which the inserted images overlap the text, can include a background image and the text. The controller 120 can separate the background image and the text and perform a process of recognizing the text. Further, the controller 120 can recognize the entire image and the text as one image as denoted by reference numeral 1135.

Further, the controller 120 can separate the background image and the text, and separately recognize each of the background image and the text as denoted by reference numeral 1137. Then, the controller 120 can correct at least one of a color, a shape, and an effect of a region, in which the text region is positioned in the background image, with a peripheral value to generate the document.

In the meantime, the electronic device according to various exemplary embodiments can generate and store the recognized images and texts for each of the documents in the form of one file or page. Further, the electronic device can share the generated document with other terminals by using a sharing program.

Although the present disclosure has been described with an exemplary embodiment, various changes and modifications can be suggested to one skilled in the art. It is intended that the present disclosure encompass such changes and modifications as fall within the scope of the appended claims.

What is claimed is:

1. A method of recognizing characters in a plurality of documents, comprising:
capturing a preview image of a plurality of document;
cropping each of the plurality of documents in the captured preview image into respective document images;
recognizing characters on each of the plurality of the document images; and
generating a document corresponding to the plurality of the document images with the recognized characters.

2. The method of claim 1, further comprising:
editing the plurality of document images according to an attribute value of a reference document.

3. The method of claim 2, further comprising:
editing at least one of aspect ratios and sizes of the document images in the captured image to be equal to an aspect ratio and a size of the reference document image.

4. The method of claim 1, wherein capturing of the preview image includes:
detecting document images included in the preview image; and
designating one of the detected document images as a reference document.

5. The method of claim 3, wherein designating the one of the detected document images includes:
when aspect ratios of the document images are different from each other, requesting a user to select a document image among the cropped document images as the reference document; and
when aspect ratios of the document images are same as each other, designating a document image having a smallest size among the document images as the reference document.

6. The method of claim 1, wherein generating the document includes:
detecting one or more of texts and inserted images included in the document image;
separating the texts and the inserted images; and
simultaneously or sequentially recognizing the texts and recognizing the inserted images.

7. The method of claim 6, wherein the recognizing of the texts includes:
when the text included in the document image includes hand-writing characters, comparing similarities between each of the hand-writing characters and each of the hand-writing fonts stored in the storage unit;
when one of the similarities exceeds a predetermined reference value, converting a hand-writing character into a hand-writing font with the exceeding similarity; and
when the similarities are equal to or lower than the predetermined reference value, requesting a creation of a hand-writing font for a handwriting character.

8. The method of claim 6, wherein recognizing the text includes converting the text included in the document image to digital data based on font information on a digital font.

9. The method of claim 6, wherein recognizing the inserted images includes:
when the inserted image and the text overlap, separating the inserted image and the text; and
correcting at least one of a color, a shape, and an effect of a region, in which the text is positioned within the inserted image, with a peripheral value.

10. The method of claim 6, wherein recognizing the inserted images includes, when a background image is included in the inserted image, separating the background image and the inserted image and recognizing the separated background image and inserted image as one image.

11. An apparatus for recognizing characters in a document, comprising:
a camera configured to capture a preview image of a plurality of document images;
a display configured to display the preview image; and
a controller configured to
crop each of the plurality of documents in the captured preview image into respective document images;
recognize characters on each of the plurality of the document images; and
generate a document corresponding to the plurality of the document images with the recognized characters.

12. The apparatus of claim 11, wherein the controller is configured to edit the plurality of document images according to an attribute value of a reference document.

13. The apparatus of claim 11, wherein the controller is configured to edit at least one of aspect ratios and sizes of the document images in the captured image to be equal to an aspect ratio and a size of the reference document image.

14. The apparatus of claim 10, wherein the controller is configured to detect document images included in the preview image, and designate one of the detected document images as a reference document.

15. The apparatus of claim 12, wherein the controller is configured to:
when aspect ratios of the document images are different from each other, request a user to select one document image among the cropped documents as the reference document; and
when aspect ratios of the document images are the same as each other, designate a document image with the smallest size among the document images as the reference document.

16. The apparatus of claim 12, wherein the controller is configured to:
detect one or more of texts and inserted images included in the document image,
separate the texts and the inserted images, and
simultaneously or sequentially recognize the texts and recognize the inserted images.

17. The apparatus of claim 14, wherein the controller is configured to:
when the text included in the document image includes hand-writing characters, compare similarities between each of the hand-writing characters and each of the hand-writing fonts stored in the storage unit;
when one of the similarities exceeds a predetermined reference value, convert a hand-writing character into a hand-writing font with the exceeding similarity; and
when the similarities are equal to or lower than the predetermined reference value, request a creation of a hand-writing font for a handwriting character.

18. The apparatus of claim 15, wherein the controller is configured to convert the text included in the document image to digital data based on font information on a digital font.

19. The apparatus of claim 15, wherein the controller is configured to, when the inserted image and the text overlap, separate the inserted image and the text, and correct at least one of a color, a shape, and an effect of a region, in which the text is positioned within the inserted image, with a peripheral value.

20. The apparatus of claim 14, wherein the controller is configured to, when a background image is included in the inserted image, separate the background image and the inserted image and recognize the separated background image and inserted image as one image.
